(19) United States
(12) Patent Application Publication
(10) Pub. No.: US 2004/0215604 A1
(43) Pub. Date: Oct. 28, 2004

(54) System and method for querying a data source

(75) Inventor: Vesselin K. Ivanov, Toronto (CA)

Correspondence Address: Samuel A. Kassatly, 6819 Trinidad Drive, San Jose, CA, 95120, US

(73) Assignee: International Business Machines Corporation, Armonk, NY

(21) Appl. No.: 10/423,180

(22) Filed: Apr. 24, 2003

(51) Int. Cl. G06F 7/00

(52) U.S. Cl. 707/3

(57) ABSTRACT

The present system and associated method are adapted to query a data source. The present system comprises a query registry that stores a plurality of SQL queries, and a query processor that receives a query command from a caller in an application, that retrieves an SQL query associated with the query command from the query registry, and that returns results of the query to the query command. The present system further comprises a data source adapter that accesses the data source to apply the SQL query associated with the query command, and that returns the results of the query to the query processor. The query command maps the results of the query to a data access object of some type and returns it to the caller. The system also comprises a module that gathers user input for each SQL query, and that generates a source code of the query command and the data access object needed to execute the query.

### FIELD OF THE INVENTION

The present invention relates generally to an improved distributed data processing system and particularly to an improved system and method for executing a query request generated by an application for querying a data source.

### BACKGROUND OF THE INVENTION

Software developers face the fundamental problem that writing an enterprise-wide application is difficult, and writing a distributed application is even more difficult. In addition, an enterprise seeks to build an application as fast as possible without being locked into one platform. Ideally, enterprise developers would like to be able to write the application once and run it on all of their platforms. Enterprise JavaBeans™ technology seeks to provide this ability. JAVA and all Java-based marks are owned by Sun Microsystems Incorporated.

JavaBeans™ is the name of a component architecture for use with the Java™ programming language. A JavaBean™ is the Java™ term for a component, which is a reusable building block of application logic that a developer can combine with other components to form an application program. Enterprise JavaBeans™ (EJB) is a server component architecture that extends the JavaBeans™ architecture to an enterprise. In this sense, the term enterprise refers to an organization that uses computers in a networking environment, typically on a very large scale.

In large-scale enterprise computing environments, a single server application may serve multiple concurrent client applications, each accessing an overlapping set of EJBs while other server applications are also accessing the EJBs. Thus, the EJB component architecture is designed to enable enterprises to build scalable, secure, multi-platform, business-critical applications as reusable, server-side components. Its purpose is to solve enterprise problems by allowing an enterprise developer to focus primarily on writing business logic.

The EJB specification creates an infrastructure that takes care of system-level programming, such as transactions, security, threading, naming, object-life cycle, resource pooling, remote access, and persistence. It also simplifies access to existing applications, and provides a uniform application development model for tool creation use.

EJBs are said to be persistent because the state of an entity bean is saved in a storage mechanism. Persistence means that the EJB exists beyond the lifetime of the application. There are two types of persistence, bean-managed and container-managed.

For bean-managed persistence, the EJB code that is written comprises calls for accessing a database. The ejbCreate method, for example, issues a Structured Query Language (SQL) insert statement. A developer is responsible for coding the insert statement and any other necessary SQL calls.

However, if the container manages an entity bean's persistence, it automatically generates the necessary database access calls. For example, when a client creates an entity bean, the container generates a SQL insert statement. The code that is written for the EJB does not comprise any SQL calls. The container also synchronizes the entity bean's instance variables with data in the underlying database. These instance variables are often referred to as container-managed fields.

Container-managed persistence (CMP) has advantages over bean-managed persistence (BMP). CMP EJBs require less code than BMP EJBs. In addition, the CMP EJBs do not contain database access calls. Consequently, the code is independent of any particular data store, such as a relational database. However, container-managed persistence has several limitations due to restrictions in the SQL they can execute.

One such limitation is a query that results in a large set. Consider, for example, a server application that provides an online store. A database is provided for storing attributes of items available in the store, for example, belts. Such attributes comprise color, material, size, style, quality, availability, and the like. The attributes may comprise an image of the belt.

A client accessing the online store requests a list of all black, leather belts available. Using a CMP EJB for servicing such a request, the application creates an instance for all black, leather belts in the database. In this instance, all attributes available for each of the black, leather belts is retrieved, regardless of whether it is required. That is, even if only the color material, size and price are requested, the remained attributes are comprised in the instance. This feature can lead to significant performance degradation, especially when there are a large number of items having a large number of attributes.

Accordingly, a solution that addresses, at least in part, this and other shortcomings and provides database read-path optimisations is desired. The need for such a system has heretofore remained unsatisfied.

### SUMMARY OF THE INVENTION

The present invention satisfies this need, and presents a system, a computer program product, and an associated method (collectively referred to herein as “the system” or “the present system”) providing a scalable, lightweight component for handling complex SQL statements, or queries, that can be readily integrated with commercially available EJB components and their corresponding application servers.

In accordance with an aspect of the present invention, there is provided a system for querying a data source, the system comprises a query registry for storing at least one SQL query; a query processor for receiving a query command from a caller in an application, retrieving an SQL query associated with the query command from the query registry, and returning results of the query to the query command; and a data source adapter for accessing the data source to apply the SQL query associated with the query command and for returning the results of the query to the query processor.

In accordance with another aspect of the present invention, there is provided a method for querying a data source, the method comprising the steps of receiving a query command at a query processor from a caller in an application; retrieving an SQL query from a query registry, the SQL query being associated with the query command; accessing the data source via a data source adaptor to apply the SQL query associated with the query command; and returning results of the SQL query to the query command.

In accordance with yet another aspect of the present invention, there is provided a computer readable media storing data and instructions readable by a computer system, the computer system executing an enterprise framework, the data and instructions for defining a lightweight object query system that, when deployed on the computer system, adapts the system to receive a query command at a query processor from a caller in an application; retrieve an SQL query from a query registry for storing at least one SQL query, the SQL query being associated with the query command; access the data source via a data source adaptor to apply the SQL query associated with the query command; and return results of the SQL query to the query command.

In accordance with yet another aspect of the present invention, there is provided a transition tool suite for facilitating conversion to a system for querying a data source, the system comprising a query registry for storing at least one SQL query; a query processor for receiving a query command from a caller in an application, retrieving an SQL query associated with the query command from the query registry, and returning results of the query to the query command; and a data source adapter for accessing the data source to apply the SQL query associated with the query command and for returning the results of the query to the query processor, wherein the transition tool suite comprises a parameter file including a plurality of predefined parameters; and a code generation component for generating code in accordance with the parameters in the parameter file for adding components to the system.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a data source querying system of the present invention can be used;

FIG. 2 is a block diagram illustrating a detailed implementation of the computer system in FIG. 1;

FIG. 3 is a functional block diagram of a server in accordance with an embodiment of the data source querying system of FIGS. 1 and 2;

FIG. 4 is a sequence diagram illustrating the execution of an exemplary query command in accordance with an embodiment of the data source querying system of FIGS. 1 and 2; and

FIG. 5 is a process flow chart illustrating the creation of a command query using a GUI-based wizard using the data source querying system of FIGS. 1 and 2.

### DETAILED DESCRIPTION OF PREFERRED EMBODIMENTS

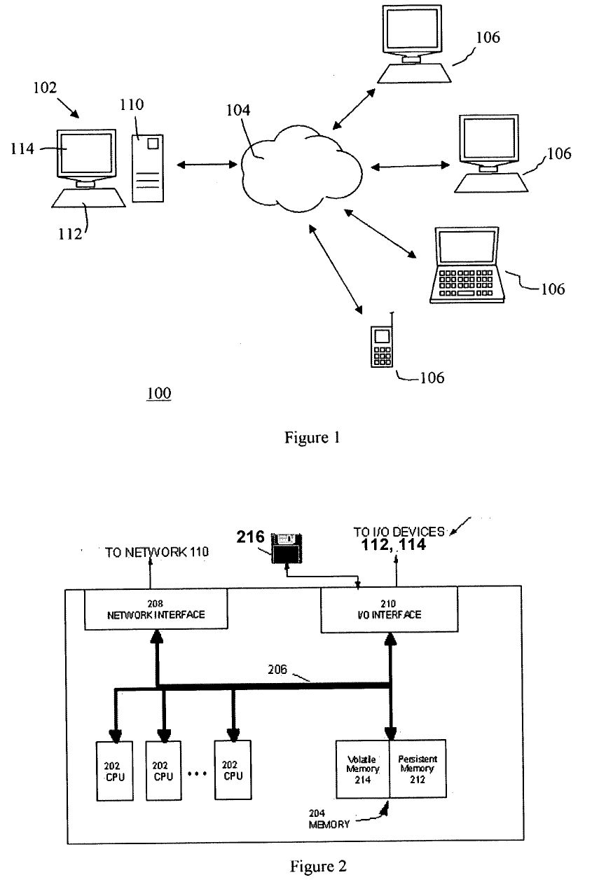

FIG. 1 illustrates an exemplary distributed computer system 100 in which a data source querying system according to the present invention can be used. The computer system 100 comprises a network computing device, or server, 102, a network 104, and a plurality of client computing devices, or clients, 106. Each of the clients 106 communicates with the server 102 via the network 104. As will be appreciated by those of ordinary skill in the art, the network 104 may be embodied using one or more conventional networking technologies, including local area networks, wide area networks, intranets, public Internet, and the like.

Throughout the description herein, aspects of the invention are described as embodied solely on the server 102. As will be appreciated by those of ordinary skill in the art, aspects of the invention may be distributed amongst one or more networked servers that interact with the server 102 via the network 104.

The server 102 comprises a processing system 110 that communicates with input devices 112, output devices 114, and the network 104. Examples of input devices 112 comprise a mouse, a keyboard, a scanner, an imaging system, and the like. Examples of output devices 114 comprise displays, printers, and the like. Additionally, combination input/output (I/O) devices 112, 114 may also be used in communication with the processing system 110. Examples of I/O devices 112, 114comprise removable and fixed recordable media such as floppy disk drives, tape drives, compact disk (CD) drives, digital video disk (DVD) drives, as well as touch screen displays and the like.

Exemplary server 102 is illustrated in greater detail in FIG. 2. As illustrated, the server 102 comprises a central processing unit (CPU) 202, memory 204, network interface (network I/F) 208 and I/O interface (I/O I/F) 210. Each component is in communication with the other components via a suitable communications bus 206 as required.

The CPU 202 is a processing unit, such as an Intel Pentium™, IBM PowerPC™, Sun Microsystems UltraSparc™ processor or the like, suitable for the operations described herein. As will be appreciated by those of ordinary skill in the art, other embodiments of the server 102 could use alternative CPUs 202 and may comprise embodiments in which one or more CPUs 202 are employed. The CPU 202 may comprise various support circuits to enable communication between itself and the other components of the server 102.

The memory 204 comprises both volatile memory 214 and persistent memory 212 for the storage of the following: operational instructions for execution by CPU 202, data registers, application storage and the like. The memory 204 comprises a combination of random access memory (RAM), read only memory (ROM) and persistent memory such as that provided by a hard disk drive.

The network I/F 208 enables communication between computer system 100 and other network computing devices via the network 104. The network I/F 208 may be embodied in one or more conventional communication devices. Examples of a conventional communication device comprise an Ethernet card, a token ring card, a modem or the like. The network I/F 208 may also enable the retrieval or transmission of instructions for execution by CPU 202 from or to a remote storage media or device via network 104.

The I/O I/F 210 enables communication between the server 102 and the various I/O devices 112, 114. The I/O I/F 210 may comprise, for example, a video card for interfacing with an external display such as the output device 114. Additionally, I/O I/F 210 may enable communication between processing system 110 and a removable media 216. Although removable media 216 is illustrated as a conventional diskette other removable memory devices such as Zip™ drives, flash cards, CD-ROMs, static memory devices and the like may also be employed. Removable media 216 may be used to provide instructions for execution by CPU 202 or as a removable data storage device. An application comprising computer instructions in accordance with an embodiment of the present invention is stored in the memory 204, thus adapting the operation of the server 102.

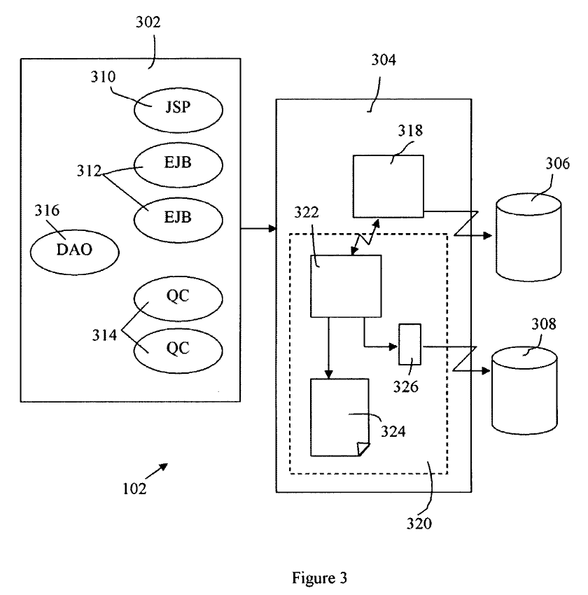

Referring to FIG. 3, a functional block diagram of a server 102 in accordance with an embodiment of the present invention is illustrated generally by numeral 300. The server 102 comprises an application 302, a runtime environment 304, and data sources 306 and 308. The application 302 comprises Java Server Pages (JSPs) 310, EJBs 312, query commands (QCs) 314, and data access objects (DAOs) 316. The runtime environment 304 comprises a Java™ 2 Platform Enterprise Edition (J2EE™) framework 318 and a lightweight object query system (LOQS) 320. The LOQS 320 further comprises a query processor 322, at least one external query registry 324, and a data source adapter 326 for each data source 306, 308 desired.

In the present embodiment, the J2EE framework 318 is International Business Machines (IBM) Corporation's Websphere Commerce Server (WCS). Accordingly, the LOQS 320 of the present embodiment is designed as an extension to the WCS to provide a framework for developing and executing efficient read-only data access commands, as required. As a result, one of the data sources 306 is used by the WCS and is referred to herein as the WCS data source 306. The other data source 308 comprises data sources other than the WCS data source 306 that may be queried, including data sources local to a merchant, and is referred to hereinafter as the local data source 308. Although for purpose of the description LOQS 320 is referred to as an extension of the WCS, a person of ordinary skill in the art will appreciate that the LOQS 320 can be developed as a stand-alone entity as well as for other implementations of the J2EE™ framework 318.

The main concept in LOQS 320 is the query command 314. The purpose of a query command 314 is to execute a predefined arbitrary SQL query. The query command 314 is then responsible for mapping a result set returning from the execution of the SQL query into at least one Data Access Object (DAO) 316.

In essence, each query command 314 is responsible for providing a name of the query to be executed, the input parameters for the query, and a method to map the query result set to the DAO 316. These methods are relatively easy to implement. Furthermore, the methods do not depend on the complexity of the SQL and most of the time the required implementation is standard and uniform. This simplicity allows for the automation of code generation for query command 314 provided by LOQS 320, as will be explained in detail later in the description.

A feature of the LOQS 320 is that the type of Data Access Object 316 returned from the query command 314 is not fixed. That is, the data access object 316 may differ for each query command 314, thus providing the desired flexibility for the application 302 to use whatever type of DAO 316 it needs. Three examples of possible data access objects 316 comprise: a light-weight JavaBean; a built-in Java type, such as string, integer, and the like, for the cases where a single column is selected or a database function like MAX or COUNT is used; and a Visual Age™ Java (VAJ) EJB Access Bean.

At the heart of the J2EE framework 318 of the LOQS 320 is the query processor 322, which is a framework controller that coordinates the activity of LOQS 320 by distributing and delegating work to its components. The query processor 322 is a session EJB 312 that plays a CommandReceiver role in a command pattern as defined in the book Design Patterns, Elements of Reusable Object Oriented Software, Erich Gamma, Richard Helm, Ralph Johnson, and John Vlissides, Addison-Wesley, 1995. The query processor 322 is the command target for the query commands 314 and is responsible for their execution. The query processor 322 communicates with the query registry 324 to obtain a trusted query for each query command 314. Thus, the query command 314 typically does not directly contain the SQL query. However, LOQS 320 provides the flexibility for a query command 314 to act as the query registry 324. Thus, the query command 314 may comprise the target SQL statement, generate it at run time, or retrieve it from a predefine location stored in the query command 314. The query processor 322 delegates all aspects of working with the data source to the data source adaptor.

As suggested above, LOQS 320 allows the actual SQL statements executed by the various query commands 314 to be stored externally in one or more query registries. This feature provides several advantages. An external registry can be useful for organizing the SQL. In addition, it provides easier access to the SQL for modification during development and testing, without requiring code changes, recompilation, and redeployment. Further, an external registry improves the simplicity for auditing, inspecting, and tuning the SQL. Yet further, better protection of the SQL may be provided by encrypting the registry or restricting its access.

The data source adapter 326 is coupled with the LOQS query processor 322, providing connectivity between the data source(s) 306, 308 and the application 302. This architecture assures seamless connectivity to multiple data sources 306, 308, as required by a variety of customers. Generally, an application 302 needs just one standard data source adapter 326 that has the capability to couple the LOQS 320 and the desired data source 306, 308. LOQS 320 provides a default implementation that is automatically configured during WCS initialization and connects to the WCS data source 306.

Multiple data source adapters 326 can be provided to LOQS 320 in a more advanced application 302. This capability enables query commands 314 deployed on the application server 102 to access different underlying data sources 306, 308. Typically, connections details such a destination data source 306, 308, data table, and the like are provided by the query command 314 to the data source adapter 326 for each data source adapter 326 to establish the required connections.

General operation of the server 102 described with reference to FIG. 3 is provided below. The query command 314 provides a new, low-level command dedicated to the execution of an SQL query. The query command 314 is called by a caller (i.e., a JSP 310) for executing a desired SQL query. The caller is usually, although not necessarily, a WCS command, or a wrapper WCS DataBean. As a WCS component, the LOQS 320 relies on the caller to provide transaction context and access control. The caller's application program interface (API) to the query command 314 is a simple one, such a lightweight JavaBean.

The query command 314 submits a query to the LOQS 320. At the LOQS 320, the data source adaptor establishes a connection to a target data source 306, 308. If the target data source 306, 308 is the WCS data source 306, the data source adapter 326 uses data source adapters (not shown) of the WCS for establishing a connection and querying the WCS data source 306. If the target data source 306, 308 is the local data source 308, connections details for the data source 306, 308 are provided by the query command 314 to the data source adapter 326, for establishing the required connection and querying the data source 306, 308. In the present embodiment, the data source adapter 326 uses Java Database Connectors (JDBC) for connecting to and querying the data sources 306, 308.

The query processor 322 retrieves an SQL query corresponding to the query command 314 from the query registry 324. Parameters of the SQL query are populated by the query command 314 and returned to the query processor 322 for processing. The SQL query is used for querying the target data source 306, 308. A result set from the SQL query is returned to the query command 314, where it is encapsulated by the Data Access Object 316 and set as output. The output is returned to the caller, where it is typically displayed to a user or customer.

From the caller's perspective, an instance of the query command 314 is obtained, the input parameters to the query are set, the query command 314 is executed, and the output DAO 316 is obtained. The DAO 316 is then used to access its attributes. If the caller is, for example, the populate( ) method of a WCS DataBean, the operation described above is the operation that will be performed in order to populate itself through a query command 314. If the caller is, for example, a WCS DataBeanCommand, it will use the same logic to populate the CommandDataBean.

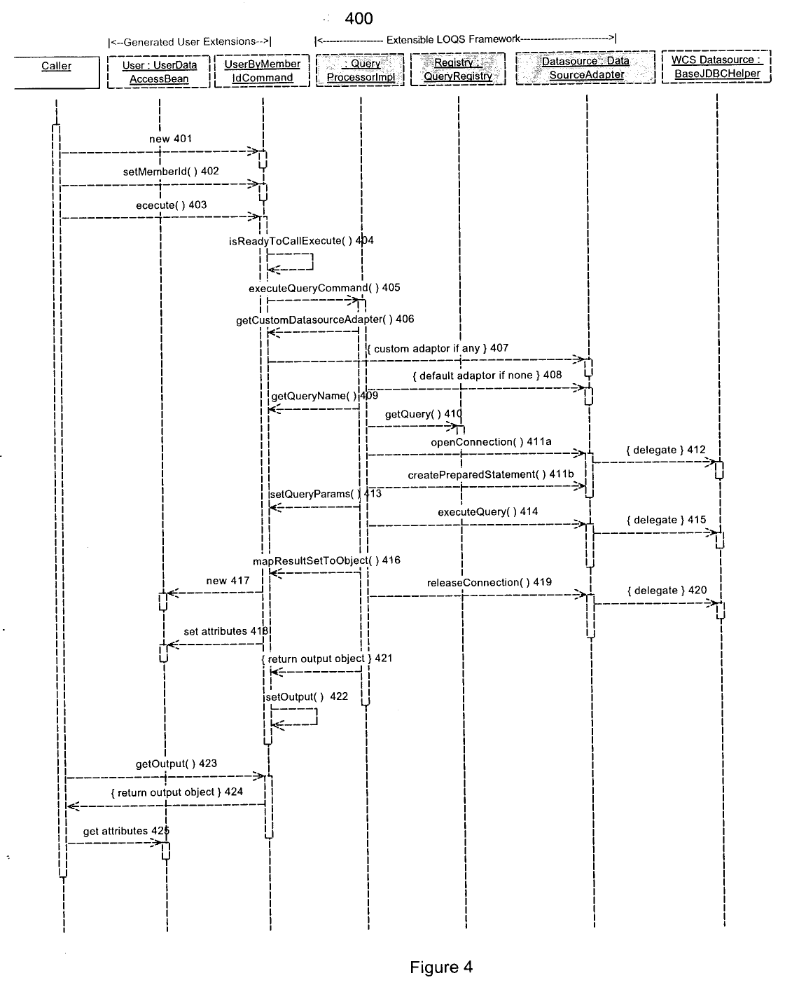

Referring to FIG. 4, a sequence diagram for the execution of an exemplary query command 314 in accordance with the present embodiment is illustrated generally by numeral 400. The query command 314 embodied by FIG. 4 is UserByMemberID, in which a person can be identified by his or her member identification (ID). Thus, the caller calls the UserByMemberID query command 314 with a request 401 for a new query. The caller also provides 402 the required parameters, which in the present example is the member ID, and requests 403 that the query be executed. The query command 314 calls itself 404 to begin executing the command.

The query command 314 sends 405 an execute query command 314 to the query processor 322, which begins by requesting 406 a target data source 306, 308 from the query command 314. If the query command 314 requires a custom data source adapter 326, it communicates 407 the details required for the connection to the data source adapter 326. If a default data source adaptor is to be used, the query processor 322 communicates 408 this information to the data source adaptor.

The query processor 322 retrieves 409 the query name UserByMemberID from the query command 314 and uses the name to retrieve 410 the associated SQL query from the query registry 324. The query processor 322 sends a request to the data source adapter 326 to open a connection 411a and to create a prepared statement 411b. A prepared statement is an object representing a precompiled SQL statement. The result of the request is a pointer to the SQL statement in the target data source 306, 308. In the present embodiment, the default data source adapter 326 is used, thus data source connectors are delegated 412 to the WCS data source adapters 326.

The query processor 322 retrieves 413 the query parameters from the query command 314. In the present embodiment, the query parameters comprise only the member ID ‘123’. The query processor 322 instructs 414 the data source adaptor to execute the query using the query parameters. Again, the data source adapter 326 delegates 415 this operation to the WCS data source 306 and returns a raw JDBC result set to the query processor 322. The query processor 322 communicates 416 the result set to the query command 314 for mapping to a DAO 316. In the present example, the DAO 316 is an Access Bean. The query command 314 creates 417 a new access bean and sets 418 attributes in accordance with the result set. In the present embodiment, the attributes associated with the member comprise name, address, and date of birth. Also, the query processor 322 releases 419 the connection to the data source connector, which, in turn, releases 420 the connection to the WCS data source connector.

The output object is returned 421 to the query command 314, which is then set 422 as the output. The caller issues 423 a request for the output and the output object, that is the Access Bean, is returned 424 from the query command 314 to the caller. The caller then accesses 425 the Access Bean for retrieving the attributes of the result.

Thus it can be seen that the LOQS 320 provides an elegant way of minimizing the amount of code and effort that is required to program a session EJB 312 to execute JDBC code. By providing specialized Session EJB 312 for executing JDBC code in a generic manner, LOQS 320 reduces the number of necessary custom Session EJBs 312 a programmer has to write and the system has to deploy and manage. As a result LOQS 320 decreases the footprint of the system and increases a developer's productivity, brings uniformity and quality to the resulting code by incorporating best practices, minimizes the likelihood of errors, and enables developers who are less proficient in EJB 312, JDBC, and WCS to achieve quality results. The query command 314 and DAOs 316 can be written directly by the developer. The programming is relatively simple as it does not rely on the complexity of the underlying SQL code, nor does it rely on advanced programming skills.

However, in order to further enhance the implementation of LOQS 320, a code generation component is provided for optionally generating the query commands 314 and DAOs 316 automatically. Thus, developers can write or generate query commands 314 that use technology for Session EJB 312 to execute read-only SQL statements without having to write low-level EJB 312 or JDBC code. Typically, the code generation component is not executed on the server 102, but on the developer's machine.

The code generation component supports both interactive and batch modes. That is, the developer can create a query command 314 individually for each SQL query or the developer can prepare a meta-data file of multiple SQL queries for creating a plurality of query commands 314.

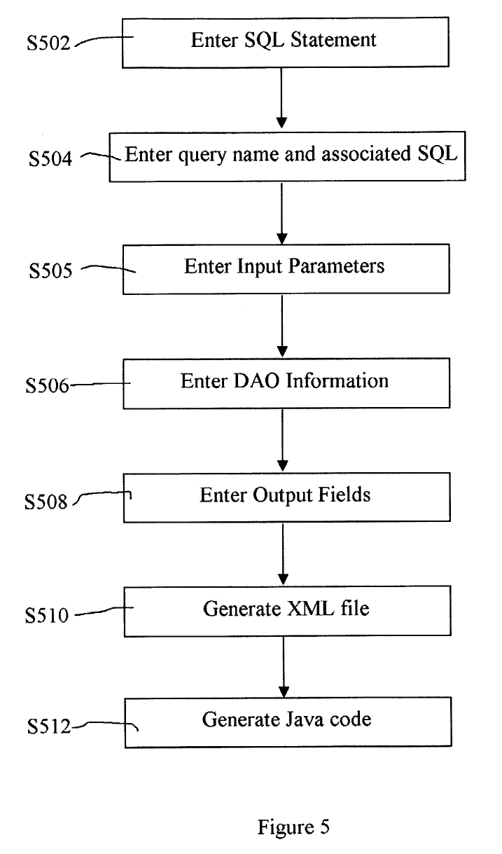

In the interactive model, the developer is provided with a graphical user interface (GUI)-based wizard. The wizard takes an SQL statement as input and interactively generates a query command 314. Referring to FIG. 5, a flowchart is provided for illustrating the operation of the interactive model. In step S502, the developer enters the SQL statement. The developer provides a reference name for the statement and the SQL statement is stored in the query registry 324. This step is optional, as the desired SQL query may already exist in the query registry 324 and thus can be read from there.

In step S504, the developer provides a name for the query command 314 as well as the name of an associated SQL statement in the query registry 324. In step S505, the developer identifies in the order of appearance the input parameters associated with the query, including the Java name and the JDBC type of each input parameter. In step S506, the developer enters the information regarding the DAO 316, including the name, class, type of DAO 316, how to handle an empty result, whether to generate a new class of DAO 316, and the like. In step S508, the developer enters information about the output fields, including the data source column name, a Java field name, an output JDBC type, a Java field type, an optional converter, and a default value.

In step S510, the wizard stores the information input in the previous steps in a meta-data file in extensible markup language (XML) format. In step S512, the LOQS 320 code generation components generates Java code for a query command 314 and data access object 316 in accordance with the meta-data stored in the XML file. These query commands 314 can then be deployed and executed within the LOQS 320 runtime. Typically, one query command 314 is provided for each SQL query but one type of DAO 316 may be used and shared by multiple SQL queries. Although the present embodiment generates the Java code from an XML file, a person of ordinary skill in the art will appreciate that the meta-data file need not be XML and can be something as simple as a text file.

In the batch mode, the developer creates one or more of the XML files described above. The XML files may be created using the wizards described above, manually created by the developer, or provided from another automation tool. The latter option is particularly useful when transitioning between commerce servers or for migration purposes in general.

For example, if a developer is upgrading or changing to WCS, there may be an existing collection of SQL queries required for the system. It may be simpler to convert the existing queries into a format readable by the code generation component and then performing a batch mode generation on all of the SQL queries for generating the corresponding query commands 314 and DAOs 316. In order to facilitate this feature, the LOQS 320 may be used in combination with a transition tool suite (TTS). The TTS integrates with the code generation aspect of the LOQS 320 and, thus, does not require a WCS to be installed on the same machine. As a result, the TTS and code generation can be deployed on any developer workstation, thus further enhancing the efficiency of adapting a J2EE runtime environment 304 such as WCS to replace an existing infrastructure.

It is to be understood that the specific embodiments of the invention that have been described are merely illustrative of certain application of the principle of the present invention. Numerous modifications may be made to the system and method for querying a data source invention described herein without departing from the spirit and scope of the present invention.

What is claimed is:

1. A system for querying a data source, comprising:
a query registry for storing at least one SQL query;
a query processor for receiving a query command in an application, for retrieving an SQL query associated with the query command from the query registry, and for returning results of the query to the query command; and
a data source adapter for accessing the data source, to apply the SQL query associated with the query command and for returning the results of the query to the query processor.

2. The system of claim 1, wherein the application further comprises a data access object for storing the results.

3. The system of claim 2, wherein the results of the query are accessible via the data access object.

4. The system of claim 1, wherein the system is coupled with an enterprise framework that provides enterprise functionality so that the system provides the enterprise framework with a lightweight query system for predefined queries.

5. The system of claim 4, wherein the framework is a J2EE platform-based framework.

6. The system of claim 5, wherein the J2EE platform based framework comprises a Websphere Commerce Server.

7. The system of claim 4, wherein the query processor comprises a setting to use a default data source adapter associated with the enterprise framework for establishing a connection with an enterprise data source.

8. The system of claim 1, wherein the query processor comprises a custom setting for receiving parameters from the query command, for establishing a connection with a custom defined data source through a custom data source adapter.

9. The system of claim 1, further comprising a code generation component for generating code required to add components to the system.

10. The system of claim 9, wherein the code generation component creates a code for generating the query command.

11. The system of claim 9, wherein the code generation component creates code for generating the data access object.

12. The system of claim 9, wherein the code generation component accesses a meta-data file including parameters required by the code generation component for generating one or more components.

13. The system of claim 12, wherein the code generation component accesses a plurality of meta-data files for performing batch code generation.

14. The system of claim 12, wherein the meta-data file is an extensible markup language file.

15. The system of claim 12, wherein the meta-data file is created by a wizard that collects the parameters from a developer via a plurality of interactive screens.

16. The system of claim 12, wherein the meta-data file comprises a program.

17. The system of claim 12, wherein the meta-data file is created by a conversion utility, for converting a file of a known format to a format required for the meta-data file.

18. A method for querying a data source, comprising:
a query processor receiving a query command in an application;
retrieving an SQL query from a query registry, the SQL query being associated with the query command;
accessing the data source via a data source adaptor to apply the SQL query associated with the query command; and
returning results of the SQL query to the query command.

19. The method of claim 18, wherein the results of the SQL query are returned to the query command via the query processor.

20. The method of claim 18, wherein the results are communicated to a data access object for storage.

21. The method of claim 20, further comprising accessing the results of the query by accessing the data access object.

22. The method of claim 18, wherein the query processor comprises a setting to use a default data source adapter associated with an associated enterprise framework for establishing a connection with an enterprise data source.

23. The method of claim 18, wherein the query processor comprises a custom setting for receiving parameters from the query command, in order to establish a connection with a custom defined data source through a custom defined data source adapter.

24. A method of generating code for creating a query command, comprising:
accessing a meta-data file that comprises a plurality of predefined parameters for defining a query; and
generating the query command using the predefined parameters in accordance with a predefined rule set.

25. The method of claim 24, further comprising generating a data access object using the predefined parameters.

26. The method of claim 24, wherein accessing a meta-data file comprises accessing a plurality of meta-data files for performing batch code generation.

27. The method of claim 24, wherein the meta-data file is an extensible markup language file.

28. The method of claim 24, further comprising using a wizard for creating the meta-data file, and using the results for creating the meta-data file; and
wherein the wizard collects the parameters via a plurality interactive screens.

29. The method of claim 24, further comprising programming the meta-data file.

30. The method of claim 24, further comprising creating the meta-data file by using a conversion utility for converting a file of a known format to a format required for the meta-data file.

31. A system having instruction codes for executing an enterprise framework, comprising:
a first set of instruction codes for receiving a query command in an application;
a second set of instruction codes for retrieving an SQL query from a query registry, the SQL query being associated with the query command;
a third set of instruction codes for accessing the data source via a data source adaptor to apply the SQL query associated with the query command; and
a fourth set of instruction codes for returning results of the SQL query to the query command.

32. The system of claim 31, further comprising a fifth set of instruction codes for returning the results of the SQL query to the first set of instruction codes.

33. The system of claim 31, further comprising a sixth set of instruction codes for communicating the results to a data access object for storage.

34. The system of claim 33, further comprising a seventh set of instruction codes for accessing the results of the query by accessing the data access object.

35. The system of claim 31, wherein the first set of instruction codes comprises establishes a connection with an enterprise data source using a default data source adapter associated with an associated enterprise framework.

36. The system of claim 31, wherein the first a connection with an enterprise data source establishes a connection with a custom defined data source via a custom defined data source adapter, for receiving parameters from the query command.

37. A system having instruction codes for defining a transition tool suite, comprising:
a first set of instruction codes for accessing a meta-data file, the meta-data file comprising a plurality of predefined parameters for defining a query; and
a second set of instruction codes for generating a query command component using the predefined parameters in accordance with a predefined rule set.

38. The system of claim 37, further comprising a third set of instruction codes for generating a data access object.

39. The system of claim 37, wherein the first set of instruction codes accesses a plurality of meta-data files for performing batch code generation.

40. A transition tool suite for facilitating conversion to a system for querying a data source, the system comprising:
a query registry for storing at least one SQL query;
a query processor for receiving a query command in an application, for retrieving an SQL query associated with the query command from the query registry, and for returning results of the query to the query command;
a data source adapter for accessing the data source to apply the SQL query associated with the query command and for returning the results of the query to the query processor;
wherein the transition tool suite comprises:
a meta-data file including a plurality of predefined parameters for defining a query; and
a code generation component for generating code in accordance with the parameters in the meta-data file for adding components to the system.

41. The transition tool suite of claim 40, wherein the code generation component creates code for generating the query command in accordance with a predefined rule set.

42. The transition tool suite of claim 40, wherein the code generation component creates code for generating the data access object in accordance with a predefined rule set.

43. The transition tool suite of claim 40, wherein the code generation component accesses a plurality of meta-data files for performing batch code generation.

44. The transition tool suite of claim 40, wherein the meta-data file is an extensible markup language file.

45. The transition tool suite of claim 40, wherein the meta-data file is created by a wizard that collects the parameters via a plurality interactive screens.

46. The transition tool suite of claim 40, wherein the meta-data file is programmable.

47. The transition tool suite of claim 40, wherein the meta-data file is created by a conversion utility for converting a file of a known format to a format required for the meta-data file.
